(19) United States
(12) Patent Application Publication
(10) Pub. No.: US 2009/0239499 A1
(43) Pub. Date: Sep. 24, 2009

(54) APPARATUSES AND METHODS FOR LOG MANAGEMENT EMPLOYED IN MOBILE STATIONS

(75) Inventors: Jyh-Chun Wang, Taipei City (TW); Ming-Jo Tarn, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/052,272

(22) Filed: Mar. 20, 2008

(51) Int. Cl. H04M 11/00

(52) U.S. Cl. 455/405

(57) ABSTRACT

A method for log management utilized in a mobile station is provided. The method includes the following steps. An accumulated history log comprising multiple accumulated history records is generated. A menu comprising multiple menu items corresponding to the accumulated history records is displayed. The accumulated history log contains no records representing redundant phone numbers.

### BACKGROUND

The invention relates to mobile stations, and more particularly, to apparatuses and methods for log management employed in mobile stations.

A conventional mobile station typically contains various call logs. A last number dialed (LND) log lists dialed numbers. A last number received (LNR) log lists received calls. A last number missed (LNM) log lists the number of the last missed call. Phone numbers recorded in the call logs aid in re-dialing numbers, placing calls among others. Conventional call logs typically store up to about twenty records sorted by time. Conventional logs, however, contain redundant phone numbers, resulting diminished storage capacity. FIG. 1 is a diagram illustrating a conventional inbox containing several redundant phone numbers.

### SUMMARY

A method of for log management is provided. An exemplary embodiment of a method for log management, employed in a mobile station, comprises the following steps. An accumulated history log comprising multiple accumulated history records is generated. A menu comprising multiple menu items corresponding to the accumulated history records is displayed. Phone numbers of any two accumulated history records are not redundant.

An embodiment of a method for log management, employed in a mobile station, comprises the following steps. A first accumulated history log comprising multiple first accumulated history records is generated. A second accumulated history log comprising multiple second accumulated history records is generated. A mixed accumulation log comprising a plurality of mixed accumulation records is generated by merging the first and second accumulated history records. A menu comprising multiple menu items corresponding to the mixed accumulation records is displayed. Phone numbers of any two first accumulated history records are not redundant. Phone numbers of any two second accumulated history records are not redundant. Phone numbers of any two mixed accumulation records are not redundant.

An embodiment of an apparatus for log management comprises a control unit and a screen coupling thereto. The control unit generates an accumulated history log comprising multiple accumulated history records. The screen displays a menu comprising multiple menu items corresponding to the accumulated history records. Phone numbers of any two accumulated history records are not redundant.

### BRIEF DESCRIPTION OF THE DRAWINGS

The invention can be more fully understood by reading the subsequent detailed description and examples with references made to the accompanying drawings, wherein:

FIG. 1 is a diagram illustrating a conventional inbox containing several redundant phone numbers;

FIG. 2A is a diagram of network environment of an embodiment of a system containing mobile stations;

FIG. 2B is a diagram of a hardware environment applicable to an embodiment of a mobile station;

FIG. 3A is an embodiment of an accumulated message sent or outgoing call log comprising four accumulated message sent or outgoing call records;

FIG. 3B is an embodiment of an accumulated message received or incoming call log comprising four accumulated message received or incoming call records;

FIG. 4 is a flowchart illustrating an embodiment of a method for modifying an accumulated message sent log;

FIG. 5 is a flowchart illustrating an embodiment of a method for modifying an accumulated outgoing call log;

FIG. 6 is a flowchart illustrating an embodiment of a method for modifying an accumulated message received log;

FIG. 7 is a flowchart illustrating an embodiment of a method for modifying an accumulated incoming call log;

FIG. 8 is a flowchart illustrating an embodiment of a method for modifying an accumulated history log;

FIGS. 9A and 9B are flowcharts illustrating an embodiment of a method for integrating two accumulated history logs;

FIG. 10 is a diagram of the menu architecture for the accumulated message sent log, accumulated message received log and mixed accumulation log.

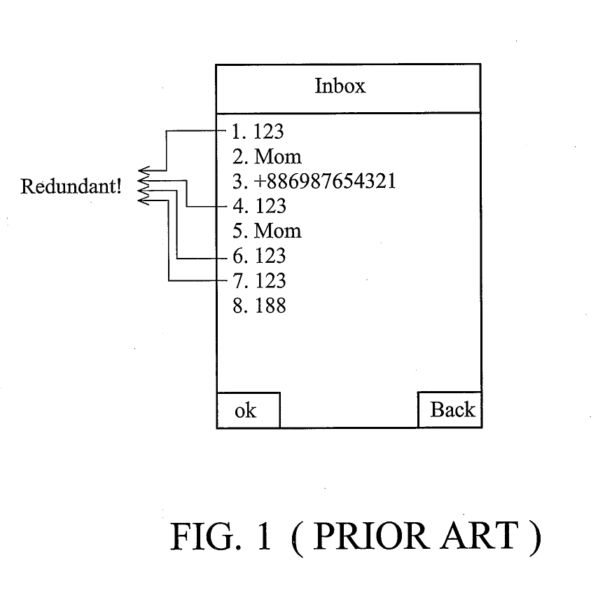

### DETAILED DESCRIPTION

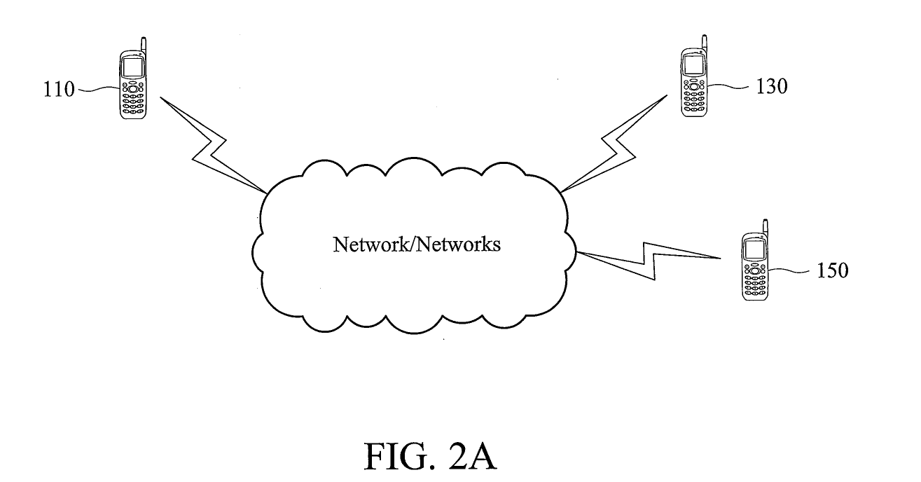

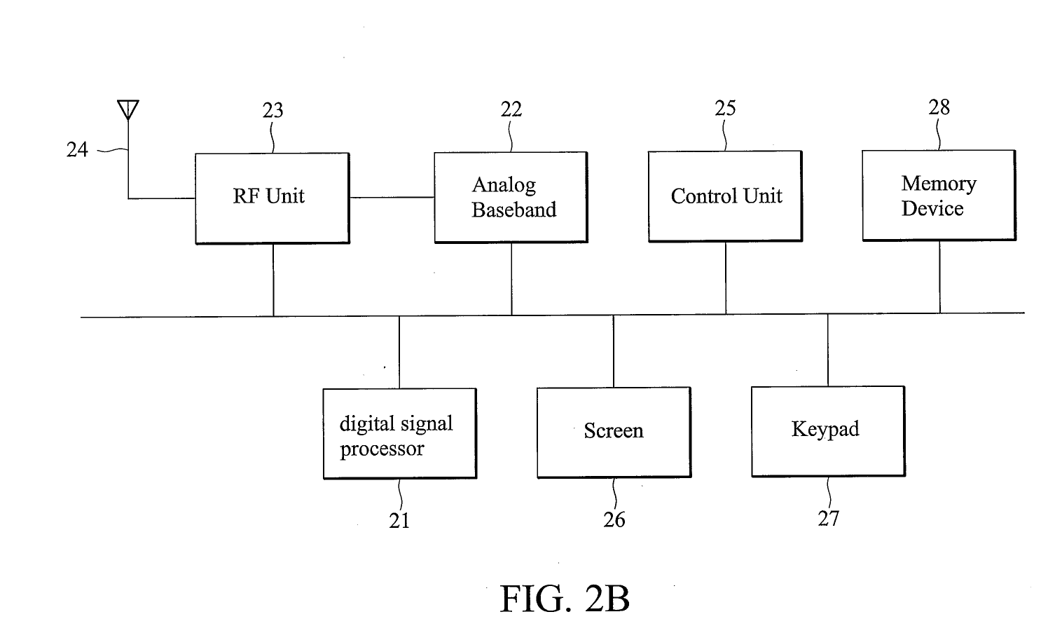

Systems for log management employed in mobile stations are provided. FIG. 2A is a diagram of network environment of an embodiment of a system containing mobile stations 110, 130 and 150. Each mobile station is equipped with a telecommunication baseband, in which a portable or mobile radio transmitter and receiver, is linked via microwave radio frequencies to base station systems (BSSs) or access points (APs) connecting a mobile station to one or more networks. The network may be a conventional telephone network, global system for mobile communications (GSM), enhanced data rates for global evolution (EDGE) or code division multiple access (CDMA) network, general packet radio service (GPRS) network, wireless local area network (WLAN), Internet or similar, or a combination thereof. Those skilled in the art will recognize that the mobile stations 110, 130 and 150 may be connected in different types of networking environments, and may communicate through various types of transmission devices such as routers, gateways, access points, base station systems (BSS) or others. Note that, various gateways established between heterogeneous networks, such as between GSM network and Internet or similar, enabling messages to be transmitted and received therebetween. The mobile station may be a mobile station, personal digital assistant (PDA), smart phone, portable media player (PMP) or similar. Each mobile station may issue phone call requests to other mobile stations or conventional telephones, and after the phone call requests are acknowledged, establish phone call connections to communicate with other mobile stations or telephones through the network. FIG. 2B is a diagram of a hardware environment applicable to an embodiment of the mobile station 110, 130 or 150, comprising a DSP (digital signal processor) 21, an analog baseband 22, an RF (Radio Frequency) unit 23, an antenna 24, a control unit 25, a screen 26, a keypad 27, and a memory device 28. The control unit 25 may be a micro-processor (MPU) unit loading and executing program modules from the memory device 28. The memory device 28 is preferably a random access memory (RAM), but may also include read-only memory (ROM) or flash memory, storing program modules.

The mobile station 110, 130 or 150 may transmit or receive short messages (SM) to or from other mobile stations via multiple intermediary devices supporting short message service (SMS). Short messages being short text messages are transmitted to and from a mobile station, a fax machine or a computer with an IP address. The SM is typically shorter than predetermined number of alphanumeric characters such as 160 or less, and contains only text. When the SM is sent, it is received by a short message service center (SMSC), which then delivers the SM to a mobile station, a fax machine or an electronic machine with an IP address. The SMSC may send a short message service (SMS) request to a home location register (HLR) to find the mobile station. When the HLR receives the request, the subscriber status corresponding to the mobile station is sent to the SMSC, the response comprising whether the mobile station is “inactive” or “active”, and where the mobile station is roaming. If the response is “inactive”, the SMSC holds the message for a period of time. When detecting that the mobile station has associated with a wireless network, the HLR sends an SMS notification to the SMSC, and the SMSC attempts to deliver the held SM to the mobile station.

The mobile station 110, 130 or 150 may transmit or receive enhanced messages to or from other mobile stations via multiple intermediary devices supporting enhanced message service (EMS). The EMS is an application-level extension to SMS for mobile stations available on wireless networks. The EM may contain a digital file. A mobile station receives the EMs further having special text formatting (such as bold or italic), animation, pictures, icons, sound effects and special ring tones.

The mobile station 110, 130 or 150 may transmit or receive multimedia messages (MMs) to or from other mobile stations via multiple intermediary devices supporting multimedia message service (MMS). The MM may contain a digital file. The MM may further contain graphics, video clips, sound files and short text messages over wireless and/or wired networks using the wireless application protocol (WAP). The MM is typically delivered to a mobile station via MMS Centers (MMSCs). MMS is typically based on the concept of multimedia messaging. The presentation of the MM is coded into a presentation file so that the images, audio and text are displayed or played back in a predetermined order as one single message. MMS, unlike email, however, does not support attachments.

The mobile station 110, 130 or 150 may transmit or receive text messages or file attachments of an e-mail to or from other mobile stations or computers. E-mails are transmitted via a message transfer agent (MTA) resident on the mobile station, and received via a mail user agent (MUA) resident on the mobile station. The MTA, also called a mail server or a mail exchange server, is a computer program or software agent transferring the e-mail from the mobile station to another electronic device, and vice versa. The MUA contacts the MTA for actual delivery of the mail. The MTA may be configured to support simple mail transfer protocol (SMTP) and/or multipurpose Internet mail extensions (MIME). SMTP is typically designed for only plain text (ASCII text), but MIME or similar enables executable programs and multimedia files to be attached to and transported with the e-mail.

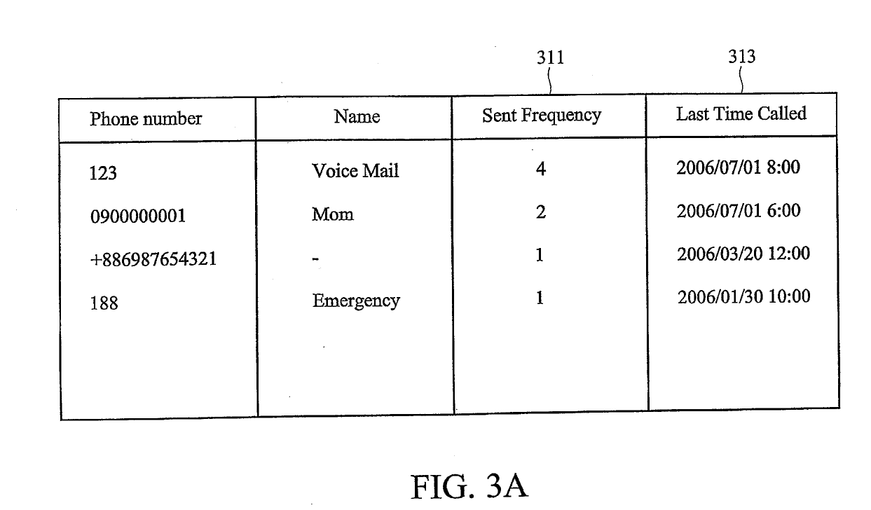

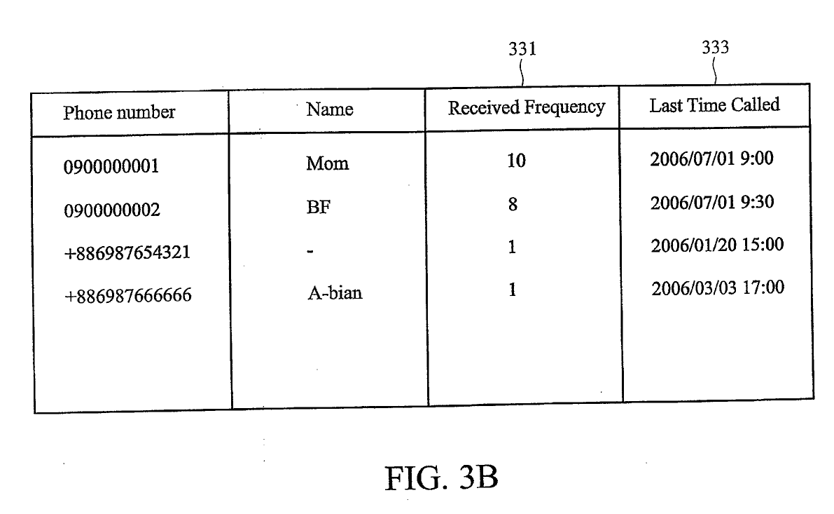

When receiving an incoming call request from a mobile station, issuing an outgoing call request to a mobile station, receiving an SM, EM, MM or E-mail from a mobile station, or transmitting an SM, EM, MM or E-mail to a mobile station, the mobile station 110, 130 or 150 generates and stores a history record in a history log, such as a last number dialed (LND), last number received (LNR), last number missed (LNM), message received, or message sent log. The history log typically stores up to about twenty records sorted by time, in which a record with an earlier timestamp is listed prior to a record with a later timestamp. Each record comprises a phone number corresponding to a mobile station of a caller or callee, sent/received frequency, and last called time. The history log may contain redundant phone numbers. The mobile station mobile station 110, 130 or 150 further generates and stores an accumulation record corresponding to one or more original records in a history log. For example, FIG. 3A is an embodiment of an accumulated message sent or outgoing call log comprising four accumulated message sent or outgoing call records. Other than records in the history log, each accumulated sent record additionally comprises two fields, a sent frequency 311 and a last time called 313. The sent frequency field 311 records the number of times a corresponding phone number has been called, or how many messages, such as SMs, EMs, MMs or E-mails, have been sent to a mobile station with a corresponding phone number. The last time called field 313 records the last time a call was placed to a corresponding phone number, or, the time at which an SM, EM, MM or E-mail was sent to a mobile station with a corresponding phone number. FIG. 3B is an embodiment of an accumulated message received or incoming call log comprising four accumulated message received or incoming call records. Similarly, each accumulated received record additionally comprises two fields, a received frequency 331 and a last time called 333. The received frequency field 331 records the number of calls received (including answered calls and missed calls) from a mobile station or a telephone with a corresponding phone number, or the number of messages, such as SMs, EMs, MMs or E-mails, received from a mobile station with a corresponding phone number. The last time called field 333 records the last time called by a mobile station or telephone with a corresponding phone number, or, the time of a last received an SM, EM, MM or E-mail from a mobile station with a corresponding phone number. Log generation is described in the following.

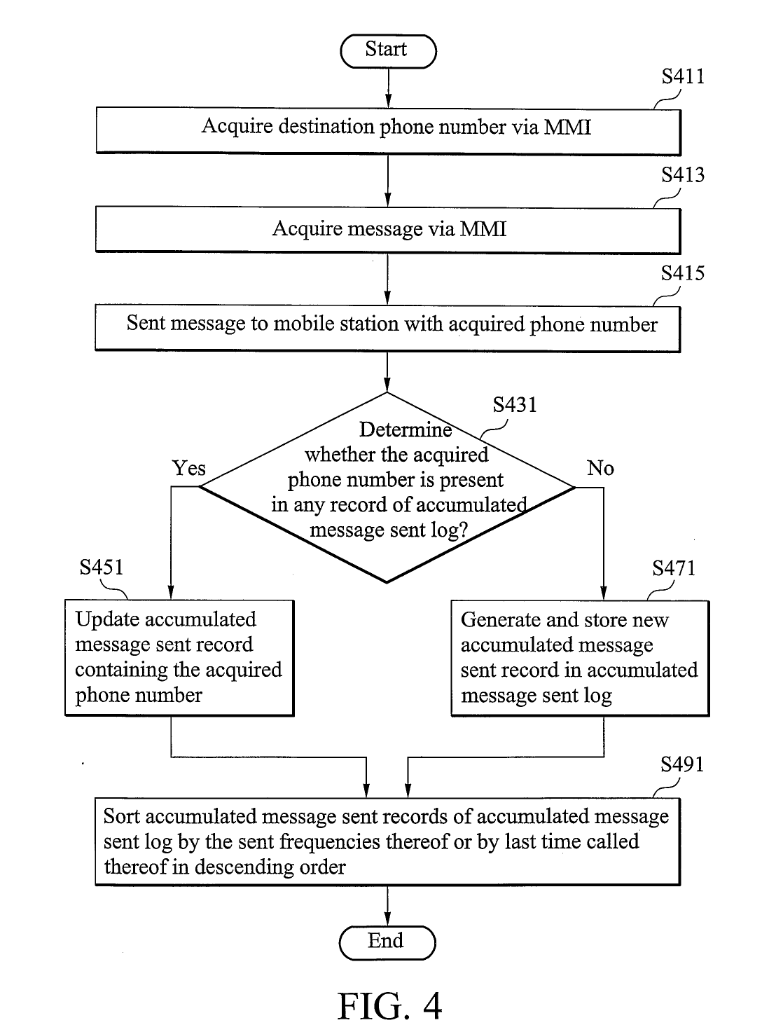

The mobile station 110, 130 or 150 may instantly modify an accumulated message sent log after sending a message, such as an SM, EM, MM or E-mail, to a mobile station with a phone number. FIG. 4 is a flowchart illustrating an embodiment of a method for modifying an accumulated message sent log, performed by the control unit 25 of the mobile station 110, 130 or 150. In step S411, a destination phone number is acquired via a man-machine-interface (MMI). In step S413, a message, such as an SM, EM, MM or E-mail, is acquired via the MMI. The MMI facilitates input of the destination phone number, SM, EM, MM or E-mail. In step S415, the message is sent to a mobile station with the destination phone number. In step S431, it is determined whether the acquired phone number is present in any record of an accumulated message sent log. If so, the process proceeds to step S451, otherwise, to step S471. The accumulated message sent log is provided in the previous description of FIG. 3A. In step S451, an accumulated message sent record containing the acquired phone number is updated to increase a sent frequency thereof (referring to 311 of FIG. 3A) by one, and update a last time called (referring to 313 of FIG. 3A) with the time at which the message was sent. In step S471, a new accumulated message sent record comprising the acquired phone number, a sent frequency of one, and a last time called with the current time is generated and stored in the accumulated message sent log. In step S491, the accumulated message sent records of the accumulated message sent log are sorted by the sent frequencies thereof or by last time called thereof in descending order.

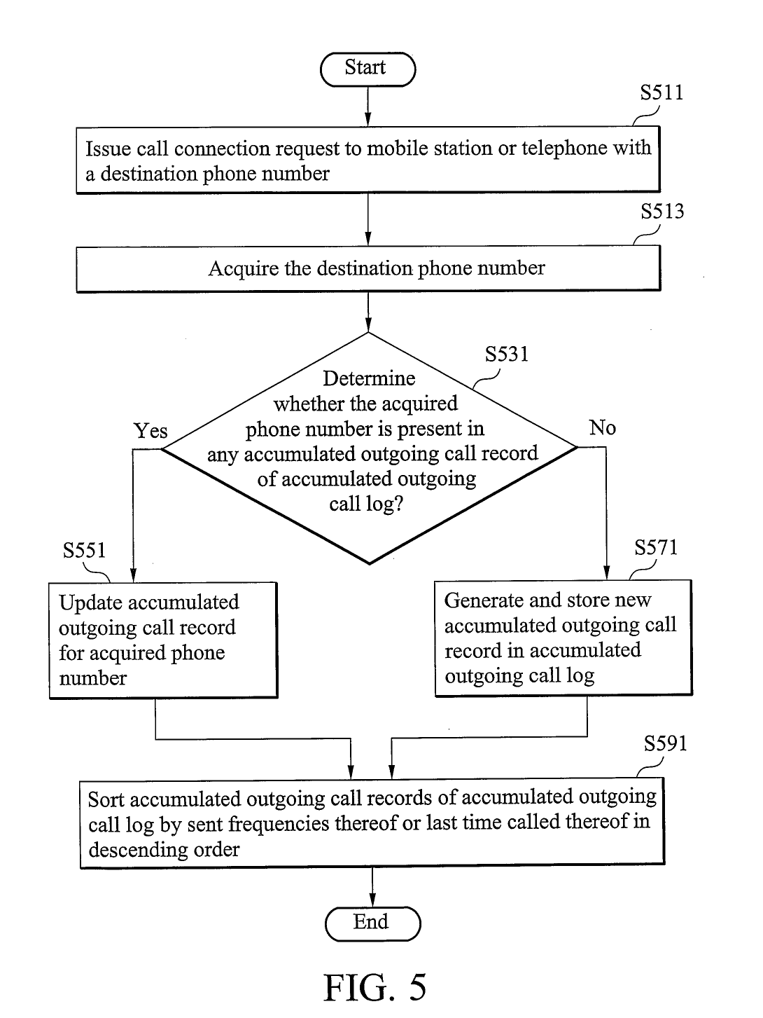

The mobile station 110, 130 or 150 may instantly modify an accumulated outgoing call log after issuing a call connection request to a mobile station or a telephone with a phone number. FIG. 5 is a flowchart illustrating an embodiment of a method for modifying an accumulated outgoing call log, performed by the control unit 25 of the mobile station 110, 130 or 150. In step S511, a call connection request is issued to a mobile station or a telephone with a destination phone number. It is to be understood that, when the call connection request is answered by the mobile station or telephone, a call connection is established therebetween for voice communication. In step S513, the destination phone number is acquired. In step S531, it is determined whether the acquired phone number is present in any accumulated outgoing call record of an accumulated outgoing call log. If so, the process proceeds to step S551, otherwise, to step S571. The accumulated outgoing call log may refer to description of FIG. 3A. In step S551, an accumulated outgoing call record for the acquired phone number is updated to increase a sent frequency thereof (referring to 311 of FIG. 3A) by one, and modify a last time called thereof (referring to 313 of FIG. 3A) with the current time. In step S571, a new accumulated outgoing call record comprising the acquired phone number, a sent frequency of one, and a last time called with the current time is generated and stored in the accumulated outgoing call log. In step S491, the accumulated outgoing call records of the accumulated outgoing call log are sorted by the sent frequencies thereof or the last time called thereof in descending order.

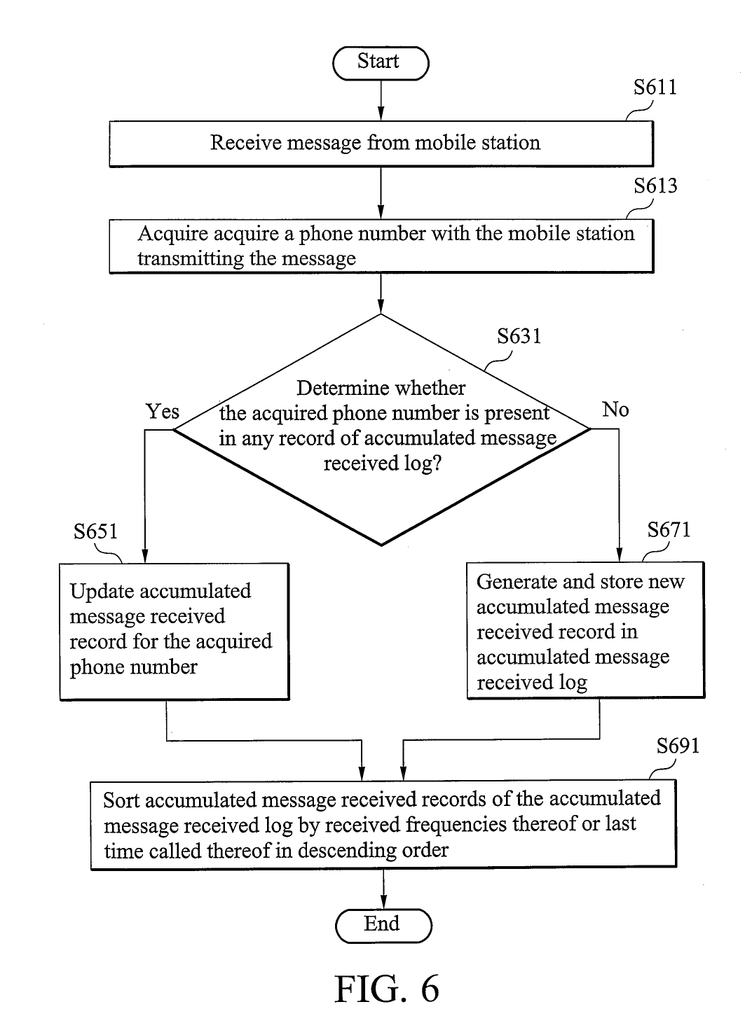

The mobile station 110, 130 or 150 may instantly modify an accumulated message received log after receiving a message, such as an SM, EM, MM or E-mail, from a mobile station with a phone number. FIG. 6 is a flowchart illustrating an embodiment of a method for modifying an accumulated message received log, performed by the control unit 25 of the mobile station 110, 130 or 150. In step S611, a message, such as an SM, EM, MM or E-mail, is received from a mobile station. In step S613, a phone number with the mobile station transmitting the message is acquired. In step S631, it is determined whether the acquired phone number is present in any record of an accumulated message received log. If so, the process proceeds to step S651, otherwise, to step S671. The accumulated message received log may refer to descriptions of FIG. 3B. In step S651, an accumulated message received record for the acquired phone number is updated to increase a received frequency thereof (referring to 331 of FIG. 3B) by one, and a last time called thereof (referring to 333 of FIG. 3B) is updated with the current time. In step S671, a new accumulated message received record comprising the acquired phone number, a received frequency of one, and a last time called with the current time is generated and stored in the accumulated message received log. In step S691, the accumulated message received records of the accumulated message received log are sorted by the received frequencies thereof or the last time called thereof in descending order.

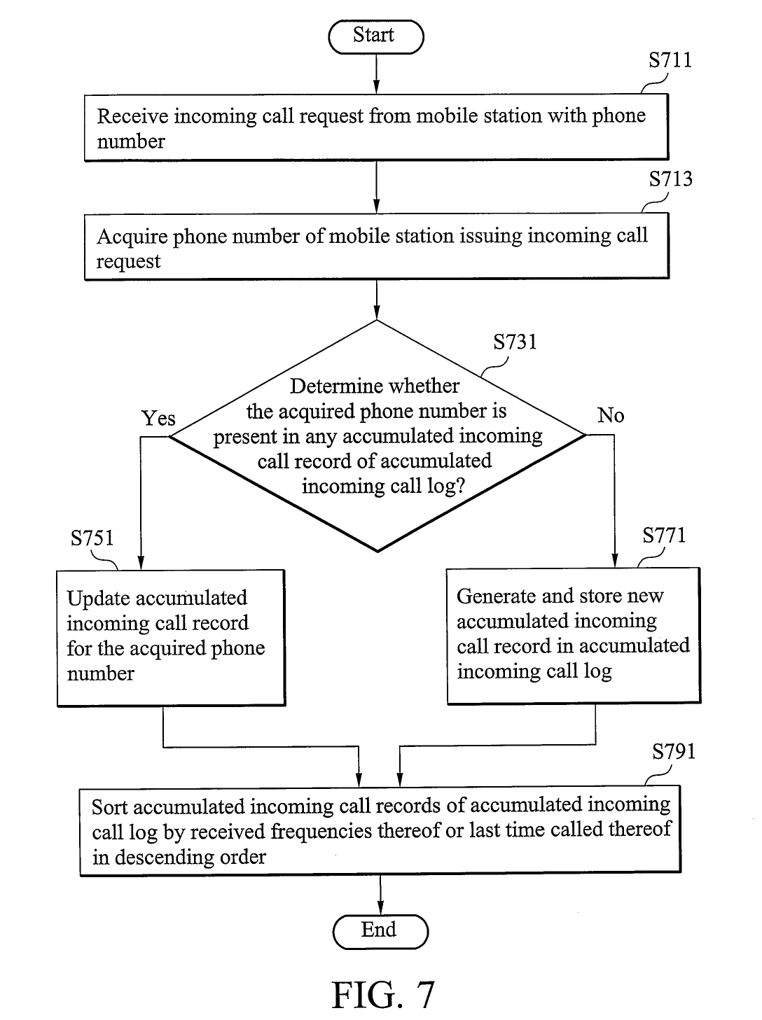

The mobile station 110, 130 or 150 may instantly modify an accumulated incoming call log after receiving an incoming call request from a mobile station with a phone number. FIG. 7 is a flowchart illustrating an embodiment of a method for modifying an accumulated incoming call log, performed by the control unit 25 of the mobile station 110, 130 or 150. In step S711, an incoming call request is received from a mobile station with a phone number. In step S713, a phone number of a mobile station issuing the incoming call request is acquired. In step S731, it is determined whether the acquired phone number is present in any accumulated incoming call record of an accumulated incoming call log. If so, the process proceeds to step S751, otherwise, to step S771. The accumulated incoming call log may refer to description of FIG. 3B. In step S751, an accumulated incoming call record for the acquired phone number is updated to increase a received frequency thereof (referring to 331 of FIG. 3B) by one, and modify a last time called thereof (referring to 333 of FIG. 3B) with the current time. In step S771, a new accumulated incoming call record comprising the acquired phone number, a received frequency of one, and a last time called with the current time is generated and stored in the accumulated incoming call log. In step S791, the accumulated incoming call records of the accumulated incoming call log are sorted by the received frequencies thereof or the last time called thereof in the descending order.

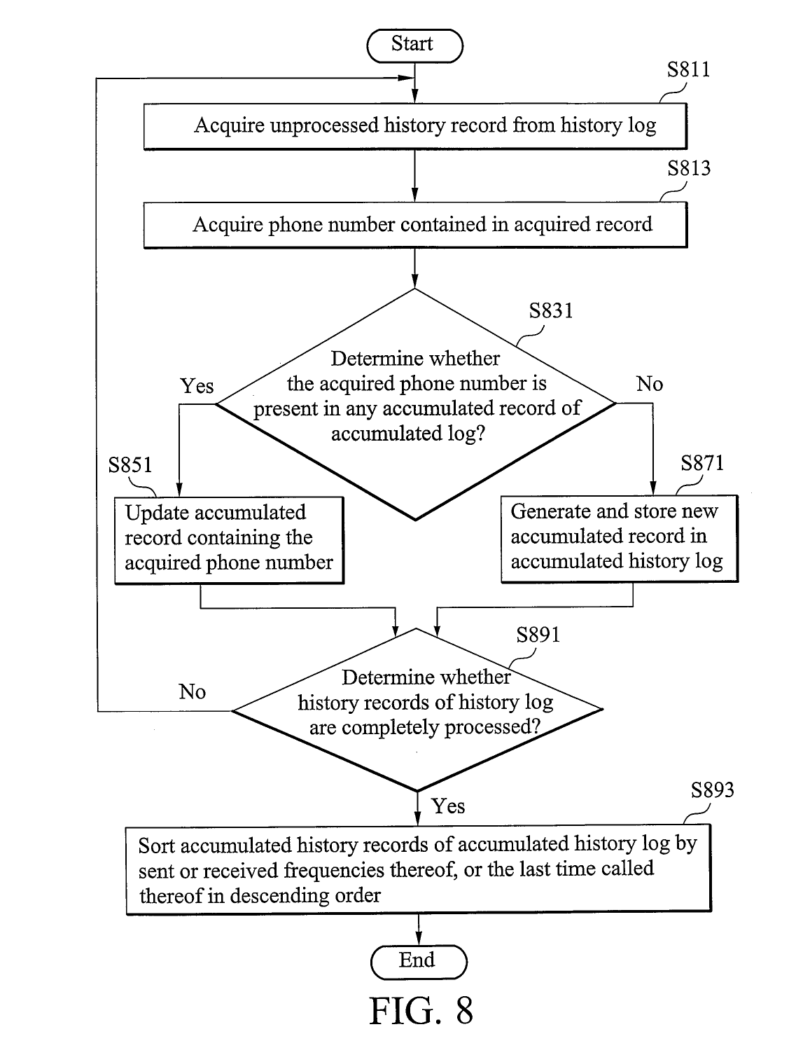

The mobile station 110, 130 or 150 may modify an accumulated history log, such as an accumulated message sent or received log, or outgoing or incoming call log after a time period, such as five or ten minutes, from the last modification. FIG. 8 is a flowchart illustrating an embodiment of a method for modifying an accumulated history log, performed by the control unit 25 of the mobile station 110, 130 or 150. In step S811, an unprocessed history record is acquired from a history log, such as a LND, LNR, LNM, message received, or message sent log. In step S813, a phone number contained in the acquired record is acquired. In step S831, it is determined whether the acquired phone number is present in any accumulated record of an accumulated log, such as an accumulated message sent or received, or outgoing or incoming call log. If so, the process proceeds to step S851, otherwise, to step S871. In step S851, an accumulated record containing the acquired phone number is updated to increase a sent frequency thereof (referring to 311 of FIG. 3A) or a received frequency thereof (referring to 331 of FIG. 3B) by one, and modify a last time called thereof (referring to 313 of FIG. 3A, or 333 of FIG. 3B) with the current time. In step S871, a new accumulated record comprising the acquired phone number, a sent or received frequency of one, and a latest established time of the current time is generated and stored in the accumulated history log. In step S891, it is determined whether history records of the history log are completely processed. If so, the process proceeds to step S893, otherwise, to step S811. In step S893, the accumulated history records of the accumulated history log are sorted by the sent or received frequencies thereof, or the last time called thereof in descending order.

The mobile station 110, 130 or 150 may integrate two accumulated history logs into a mixed log after a time period, such as five or ten minutes, from the last integration, for example, integrating accumulated message sent and received log into a mixed log, integrating accumulated outgoing and incoming call logs into a mixed log, and similar. Similarly, the accumulated message sent log and outgoing call log can be merged to be a sent log as shown in FIG. 3A, and the accumulated message received log and incoming call log can be merged to be a received log as shown in FIG. 3B.

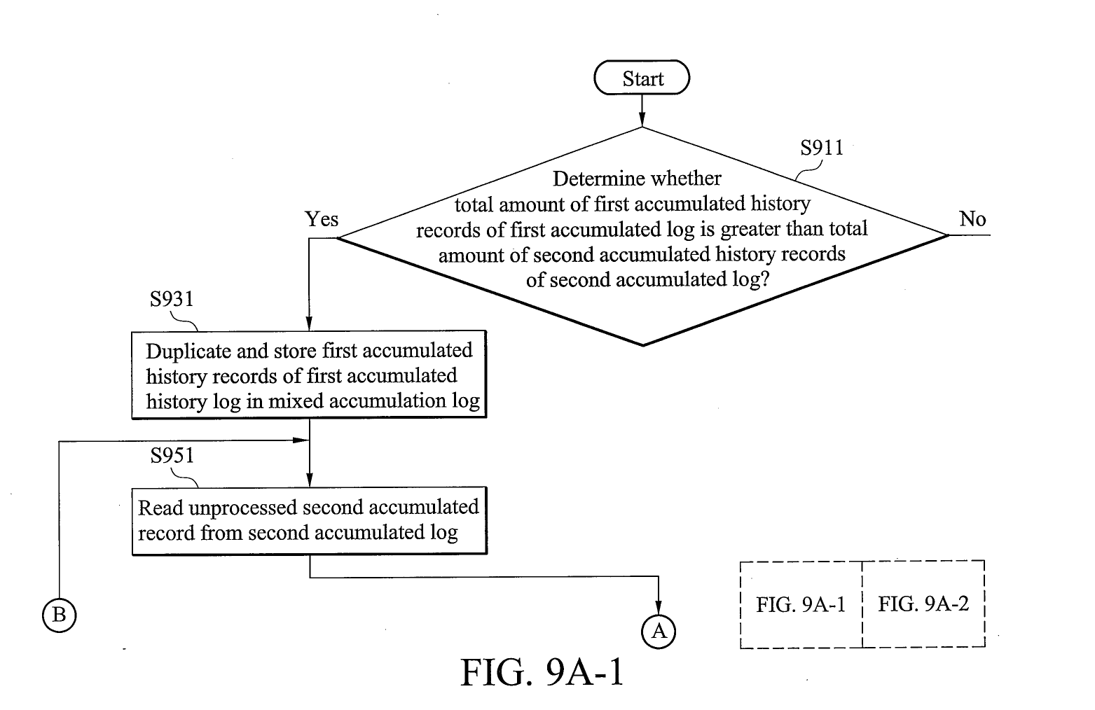

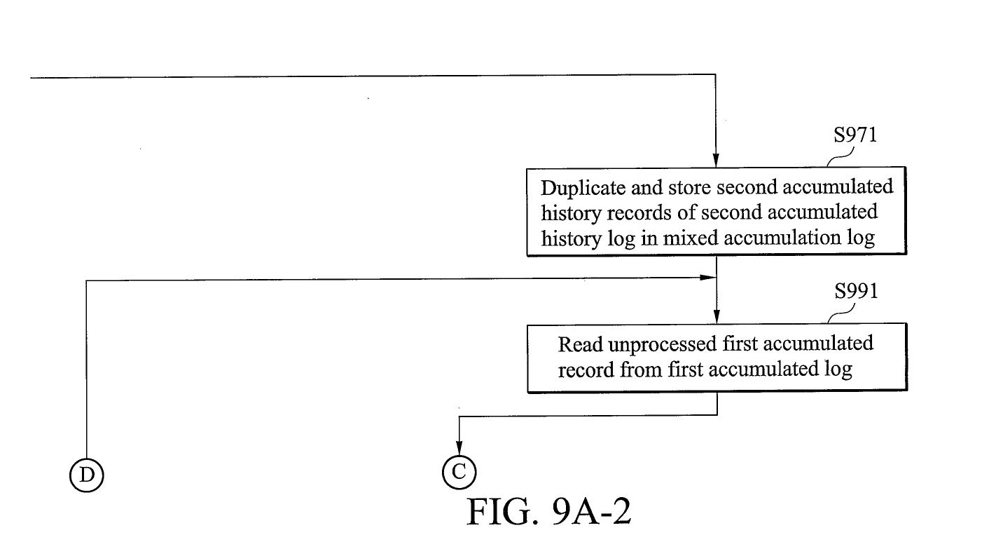

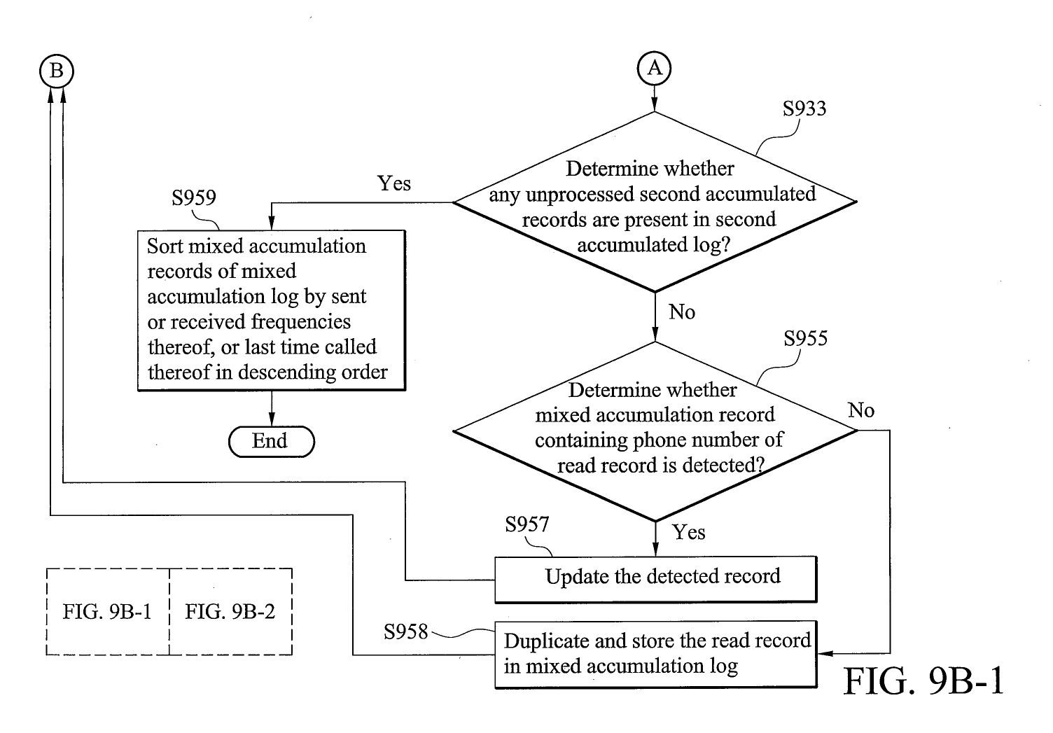

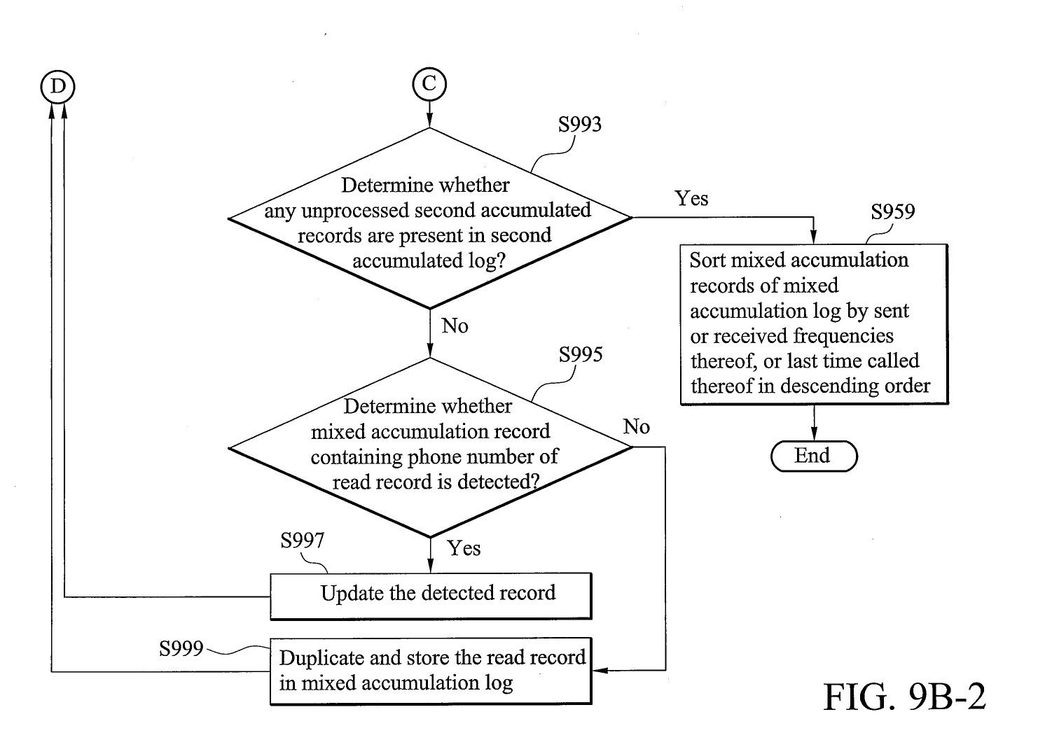

FIGS. 9A and 9B are flowcharts illustrating an embodiment of a method for integrating two accumulated history logs, referred to as first and second accumulated history logs, into a mixed accumulation log, performed by the control unit 25 of the mobile station 110, 130 or 150. The mixed accumulation log is initially empty. In step S911, it is determined whether a total amount of first accumulated history records of a first accumulated log is greater than a total amount of second accumulated history records of a second accumulated log. If so, the process proceeds to step S931, otherwise to step S971. Steps S931 to S959 describe a flow of generating the mixed accumulation log by merging the second accumulated log into the first accumulated log, while, steps S971 to S999 describe a flow of generating the mixed accumulation log by merging the first accumulated log into the second accumulated log. In step S931, the first accumulated history records of the first accumulated history log are duplicated and stored in the mixed accumulation log. In step S951, an unprocessed second accumulated record is read from the second accumulated log. In step S953, it is determined whether any unprocessed second accumulated records are present in the second accumulated log. If so, the entire process proceeds to step S959, otherwise, to step S955. In step S955, it is determined whether a (i.e. a first accumulated history record) containing the phone number of the read record is detected. If so, the process proceeds to step S957 to update the detected record, otherwise, to step S958 to duplicate and store the read record into the mixed accumulation log. Specifically, in step S957, the sent or received frequency of the detected record is increased by the sent or received frequency of the read record. Furthermore, the last time called of the detected record is replaced with the last time called of the read record when the last time called of the detected record is earlier than the last time called of the read record. In step S958, the read record is duplicated and stored in the mixed accumulation log. In step S959, the mixed accumulation records of the mixed accumulation log are sorted by the sent or received frequencies thereof, or the last time called thereof in descending order. Those skilled in the art may deduce details of steps S971 to S999 by analogy with reference to descriptions of steps S931 to S959.

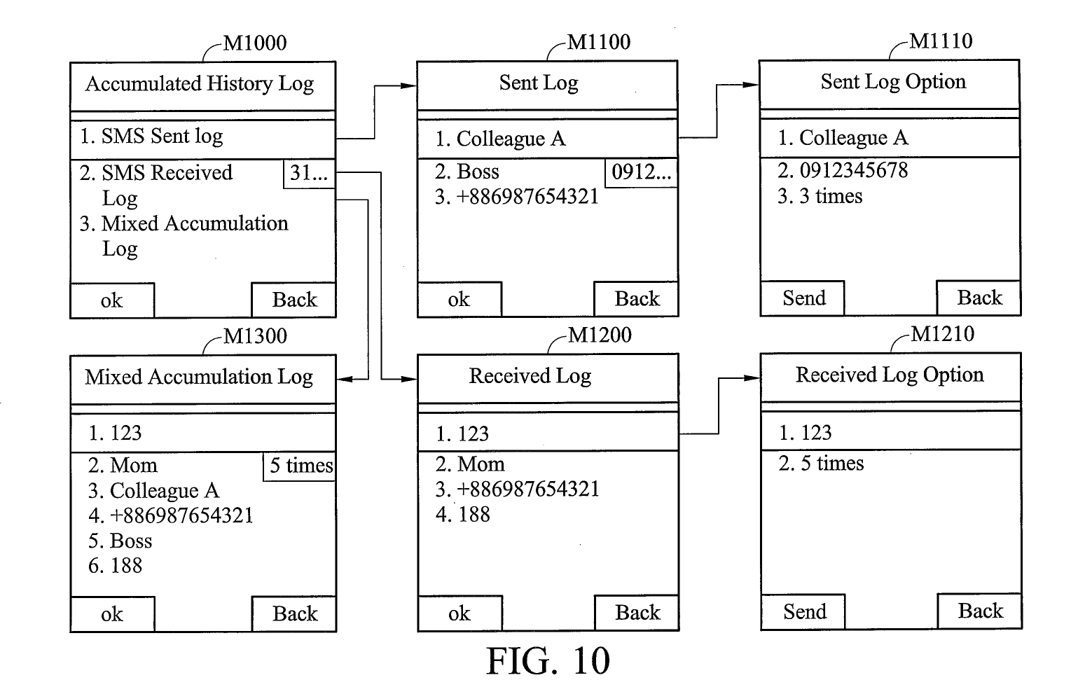

The utilization of the generated logs is described in the following. FIG. 10 is a diagram of the menu architecture for the described accumulated message sent log, accumulated message received log and mixed accumulation log, displayed by the screen 26 of the mobile station 110, 130 or 150. The mobile station 110, 130 or 150 displays a menu M1000 containing three menu items respectively entitled “SMS Sent log”, “SMS Received Log” and “Mixed Accumulation Log”. When the menu item “SMS sent log” is selected and entered, a sent log menu M1100 comprising three menu items for different phone numbers is displayed. The menu items of the sent log menu M1100 are extracted from the described accumulated message sent log. When one menu item of the sent log menu M1100 is selected and entered, details of the selected menu item are displayed in a sent log option menu M1110, comprising a name, a phone number and a sent frequency. Subsequently an outgoing call request may be issued or an SM may be sent to a mobile station with the indicated phone number via the sent log option menu M1110. When a menu item “SMS Received Log” is selected and entered, a received log menu M1200 displays four menu items corresponding to different phone numbers. The menu items of the received log menu M1200 are extracted from the described accumulated message received log. When one menu item of the received log menu M1200 is selected and entered, details of the selected menu item are displayed in a received log option menu M1210, comprising a phone number and a received frequency. Subsequently, an outgoing call request to a mobile station with the indicated phone number may be issued via the received log option menu M1210. Similarly, when a menu item “Mixed accumulation Log” is selected and entered, a mixed accumulation log menu M1300 displays six menu items corresponding to different phone numbers. The menu items are extracted from the described mixed accumulation log.

Apparatuses, methods for log management, or certain aspects or portions thereof, may take the form of program codes (i.e., instructions) embodied in tangible media, such as floppy diskettes, CD-ROMS, hard drives, or any other machine-readable storage medium, wherein, when the program codes are loaded into and executed by a machine, such as a computer, a DVD recorder or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, such as a computer, the machine becomes an apparatus for practicing the invention. When implemented on a general-purpose processor, the program codes combine with the processor to provide a unique apparatus that operate analogously to specific logic circuits.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in the art can make various alterations and modifications without departing from the scope and spirit of the invention. Therefore, the scope of the invention shall be defined and protected by the following claims and their equivalents.

What is claimed is:

1. A method for log management, employed in a mobile station, comprising:
generating an accumulated history log comprising a plurality of accumulated history records, wherein each accumulated history record comprises a phone number; and
displaying a menu comprising a plurality of menu items corresponding to the accumulated history records,
wherein phone numbers of any two accumulated history records are not redundant.

2. The method as claimed in claim 1, wherein each accumulated history record comprises a frequency representing the number of times the phone number has been called by the mobile station, the number of messages sent to a mobile station with the phone number, the number of calls received from the phone number, the number of messages received from a mobile station with the phone number, or sum of any combination of two or more than two of the mentioned numbers.

3. The method as claimed in claim 1 wherein the generating step further comprises:
acquiring a phone number after receiving one message from a mobile station with the phone number, transmitting one message to a mobile station with the phone number, receiving an incoming call request from the phone number, or requesting a call connection with the phone number;
determining whether the acquired phone number is present in any accumulated history record of the accumulated history log; and
generating and storing a new accumulated history record in the accumulated history log, comprising the acquired phone number.

4. The method as claimed in claim 2 wherein the generating step further comprises:
acquiring a phone number after receiving one message from a mobile station with the phone number, transmitting one message to a mobile station with the phone number, receiving an incoming call request from the phone number, or requesting a call connection with the phone number;
determining whether the acquired phone number is present in any accumulated history record of the accumulated history log;
updating the detected accumulated history record by increasing the frequency thereof by one when determining the acquired phone number is present in any accumulated history record of the accumulated history log; and
generating and storing a new accumulated history record in the accumulated history log, comprising the acquired phone number and a frequency of one.

5. The method as claimed in claim 1 wherein in the generating step further comprises:
acquiring a phone number from an unprocessed history record of a history log after a time period from the last modification of the accumulated history log;
determining whether the acquired phone number is present in any accumulated history record of the accumulated history log; and
generating and storing a new accumulated history record in the accumulated history log, comprising the acquired phone number.

6. The method claimed in claim 4 wherein the generating step further comprises sorting the accumulated history records according to the frequencies thereof.

7. The method as claimed in claim 1 wherein each accumulated history record comprises a last time called for the phone number by the mobile station, a recent message sent to a mobile station with the phone number, a recent received call from the phone number, or a recent messages received from a mobile station with the phone number.

8. The method as claimed in claim 7 wherein the generating step further comprises:
acquiring a phone number after receiving one message from a mobile station with the phone number, transmitting one message to a mobile station with the phone number, receiving an incoming call request from the phone number, or requesting a call connection with the phone number;
determining whether the acquired phone number is present in any accumulated history record of the accumulated history log;
updating the detected accumulated history record by updating the last time called with the current time when determining the acquired phone number is present in any accumulated history record of the accumulated history log; and
generating and storing a new accumulated history record in the accumulated history log, comprising the acquired phone number and a last time called with the current time.

9. The method claimed in claim 8 wherein the generating step further comprises sorting the accumulated history records according to the last time called thereof.

10. The method as claimed in claim 2 wherein the generating step further comprises:
acquiring a phone number from an unprocessed history record of a history log after a time period from the last modification of the accumulated history log;
determining whether the acquired phone number is present in any accumulated history record of the accumulated history log;
updating the detected accumulated history record by increasing the frequency by one when determining the acquired phone number is present in any accumulated history record of the accumulated history log; and
generating and storing a new accumulated history record in the accumulated history log, comprising the acquired phone number and a frequency of one.

11. The method as claimed in claim 7 wherein the generating step further comprises:
acquiring a phone number from an unprocessed history record of a history log after a time period from the last modification of the accumulated history log;
determining whether the acquired phone number is present in any accumulated history record of the accumulated history log;
updating the detected accumulated history record by updating the last time called with the current time when determining the acquired phone number is present in any accumulated history record of the accumulated history log; and
generating and storing a new accumulated history record in the accumulated history log, comprising the acquired phone number and a last time called with the current time.

12. A method for log management, employed in a mobile station, comprising:
generating a first accumulated history log comprising a plurality of first accumulated history records;
generating a second accumulated history log comprising a plurality of second accumulated history records;
generating a mixed accumulation log comprising a plurality of mixed accumulation records by merging the first and second accumulated history records; and
displaying a menu comprising a plurality of menu items corresponding to the mixed accumulation records,
wherein phone numbers of any two first accumulated history records are not redundant, phone numbers of any two second accumulated history records are not redundant, and phone numbers of any two mixed accumulation records are not redundant.

13. The method as claimed in claim 12 wherein each first or second accumulated history record, or mixed accumulation record comprises a phone number and a frequency representing the number of times the phone number has been called by the mobile station, the number of messages sent to a mobile station with the phone number, the number of calls received from the phone number, or the number of messages received from a mobile station with the phone number.

14. The method as claimed in claim 12 wherein each first or second accumulated history record, or mixed accumulation record comprises a phone number and a last time called, at which the phone number had recently been called by the mobile station, a recent message had been sent to a mobile station with the phone number, a recent incoming call had been received from the phone number, or a recent messages had been received from a mobile station with the phone number.

15. The method as claimed in claim 12, further comprising:
determining whether total amount of the first accumulated history records of the first accumulated history log exceeds total amount of the second accumulated history records of the second accumulated history log, and if so, duplicating and storing the first accumulated history log in the mixed accumulation log;
reading unprocessed second accumulated history records from the second accumulated history log;
determining whether any unprocessed second accumulated history records are present in the second accumulated history log, and if so, sorting the mixed accumulation records of the mixed accumulation log.

16. The method as claimed in claim 15, further sorting the mixed accumulation records of the mixed accumulation log according to the sent or received frequencies thereof, or the last time called thereof in descending order.

17. The method as claimed in claim 15, further comprising:
determining whether any unprocessed second accumulated history records are present in the second accumulated history log, and if not, determining whether the mixed accumulation record containing the phone number of the read record is detected, and if so, updating the detected record, otherwise duplicating and storing the read record in the mixed accumulation record.

18. An apparatus for log management, comprising:
a control unit generating an accumulated history log comprising a plurality of accumulated history records, wherein each accumulated history record comprises a phone number; and
a screen coupling to the control unit, displaying a menu comprising a plurality of menu items corresponding to the accumulated history records,
wherein phone numbers of any two accumulated history records are not redundant.

19. The apparatus as claimed in claim 18, wherein each accumulated history record comprises a frequency representing the number of times the phone number has been called by the mobile station, the number of messages sent to a mobile station with the phone number, the number of calls received from the phone number, the number of messages received from a mobile station with the phone number, or sum of any combination of two or more than two of the mentioned numbers.

20. The apparatus as claimed in claim 18, wherein the control unit further performs steps of:
acquiring a phone number after receiving one message from a mobile station with the phone number, transmitting one message to a mobile station with the phone number, receiving an incoming call request from the phone number, or requesting a call connection with the phone number;
determining whether the acquired phone number is present in any accumulated history record of the accumulated history log; and
generating and storing a new accumulated history record in the accumulated history log, comprising the acquired phone number.

21. The apparatus as claimed in claim 19 wherein the control unit acquires a phone number after receiving one message from a mobile station with the phone number, transmitting one message to a mobile station with the phone number, receiving an incoming call request from the phone number, or requesting a call connection with the phone number, determines whether the acquired phone number is present in any accumulated history record of the accumulated history log, updates the detected accumulated history record by increasing the frequency thereof by one when determining the acquired phone number is present in any accumulated history record of the accumulated history log, and generates and stores a new accumulated history record in the accumulated history log, comprising the acquired phone number and a frequency of one.

22. The apparatus as claimed in claim 21, wherein the control unit further sorts the accumulated history records according to the frequencies thereof.

23. The apparatus as claimed in claim 18, wherein the control unit further performs steps of:
acquiring a phone number from an unprocessed history record of a history log after a time period from the last modification of the accumulated history log;
determining whether the acquired phone number is present in any accumulated history record of the accumulated history log; and
generating and storing a new accumulated history record in the accumulated history log, comprising the acquired phone number.

24. The apparatus as claimed in claim 18 wherein each accumulated history record comprises a phone number and a last time called for the phone number by the mobile station, a recent message sent to a mobile station with the phone number, a recent received call from the phone number, or a recent messages received from a mobile station with the phone number.

25. The apparatus as claimed in claim 24 wherein the control unit acquires a phone number after receiving one message from a mobile station with the phone number, transmitting one message to a mobile station with the phone number, receiving an incoming call request from the phone number, or requesting a call connection with the phone number, determines whether the acquired phone number is present in any accumulated history record of the accumulated history log, updates the detected accumulated history record by updating the last time called with the current time when determining the acquired phone number is present in any accumulated history record of the accumulated history log, and generates and stores a new accumulated history record in the accumulated history log, comprising the acquired phone number and a last time called with the current time.

26. The apparatus as claimed in claim 25, wherein the control unit further sorts the accumulated history records according to the last time called thereof.

27. The apparatus as claimed in claim 19 wherein the control unit acquires a phone number from an unprocessed history record of a history log after a time period from the last modification of the accumulated history log, determines whether the acquired phone number is present in any accumulated history record of the accumulated history log, updates the detected accumulated history record by increasing the frequency by one when determining the acquired phone number is present in any accumulated history record of the accumulated history log, and generates and stores a new accumulated history record in the accumulated history log, comprising the acquired phone number and a frequency of one.

28. The apparatus as claimed in claim 24, wherein the control unit further performs steps of:
acquiring a phone number from an unprocessed history record of a history log after a time period from the last modification of the accumulated history log;
determining whether the acquired phone number is present in any accumulated history record of the accumulated history log;
updating the detected accumulated history record by updating the last time called with the current time when determining the acquired phone number is present in any accumulated history record of the accumulated history log; and
generating and storing a new accumulated history record in the accumulated history log, comprising the acquired phone number and a last time called with the current time.

29. An apparatus for log management, comprising:
a control unit, generating a first accumulated history log comprising a plurality of first accumulated history records, generating a second accumulated history log comprising a plurality of second accumulated history records, and generating a mixed accumulation log comprising a plurality of mixed accumulation records by merging the first and second accumulated history records;
a screen, coupling to the control unit, displaying a menu comprising a plurality of menu items corresponding to the mixed accumulation records,
wherein phone numbers of any two first accumulated history records are not redundant, phone numbers of any two second accumulated history records are not redundant, and phone numbers of any two mixed accumulation records are not redundant.

30. The apparatus as claimed in claim 29, wherein each first or second accumulated history record, or mixed accumulation record comprises a phone number and a frequency representing the number of times the phone number has been called by the mobile station, the number of messages sent to a mobile station with the phone number, the number of calls received from the phone number, or the number of messages received from a mobile station with the phone number.

31. The apparatus as claimed in claim 29, wherein each first or second accumulated history record, or mixed accumulation record comprises a phone number and a last time called, at which the phone number had recently been called by the mobile station, a recent message had been sent to a mobile station with the phone number, a recent incoming call had been received from the phone number, or a recent messages had been received from a mobile station with the phone number.

32. The apparatus as claimed in claim 29, wherein the control unit further performs steps of:
determining whether total amount of the first accumulated history records of the first accumulated history log exceeds total amount of the second accumulated history records of the second accumulated history log, and if so, duplicating and storing the first accumulated history log in the mixed accumulation log;
reading unprocessed second accumulated history records from the second accumulated history log;
determining whether any unprocessed second accumulated history records are present in the second accumulated history log, and if so, sorting the mixed accumulation records of the mixed accumulation log.

33. The apparatus as claimed in claim 32, wherein the control unit further sorts the mixed accumulation records of the mixed accumulation log according to the sent or received frequencies thereof, or the last time called thereof in descending order.

34. The apparatus as claimed in claim 32, wherein the control unit further performs steps of:
determining whether any unprocessed second accumulated history records are present in the second accumulated history log, and if not, determining whether the mixed accumulation record containing the phone number of the read record is detected, and if so, updating the detected record, otherwise duplicating and storing the read record in the mixed accumulation record.
